(19) United States
(12) Patent Application Publication
(10) Pub. No.: US 2018/0361783 A1
(43) Pub. Date: Dec. 20, 2018

(54) KITS, SYSTEMS, AND METHODS FOR RECREATING A DIGITAL IMAGE AS PHYSICAL ART

(71) Applicant: Cupixel, Inc., Newton, MA (US)

(72) Inventors: Elad Katav, Newton, MA (US); Avner Sadot, Tel Aviv (IL); Yoav Dracher, Tel Aviv (IL); Guy Dvir, Tel Aviv (IL); Ido Ophir, Tel Aviv (IL)

(21) Appl. No.: 16/008,516

(22) Filed: Jun. 14, 2018

Related U.S. Application Data
(60) Provisional application No. 62/596,426, filed on Dec. 8, 2017.
(60) Provisional application No. 62/521,847, filed on Jun. 19, 2017.

(51) Int. Cl. B44D 2/00; B44C 5/04; G06Q 50/04

(52) U.S. Cl. CPC B44D 2/002; G06Q 50/04; B44C 5/0453

(57) ABSTRACT

A method of manufacturing a set of paintable pieces with display faces. The pieces are configured to be assembled together such that the display faces can be arranged side-by-side to form an artwork canvas. The method includes: (a) positioning a canvas piece against an inside surface of one portion of a mold; (b) securing a second portion of the mold to the first portion to form a mold cavity containing the canvas piece; (c) feeding a molten polymer into the mold cavity such that the polymer fills the mold cavity and solidifies to form a paintable piece with the canvas piece forming the display face; (d) separating the portions of the mold and removing the paintable piece from the mold cavity; and (e) repeating steps (a) through (d) a plurality of times to manufacture a set of paintable pieces. Paintable pieces and kits containing paintable pieces are also disclosed.

### CROSS REFERENCE TO RELATED APPLICATIONS

This application claims priority from (1) U.S. Provisional Patent Application No. 62/596,426 filed on Dec. 8, 2017 entitled KITS, SYSTEMS, AND METHODS FOR RECREATING A DIGITAL IMAGE AS PHYSICAL ART and (2) U.S. Provisional Patent Application No. 62/521,847 filed on Jun. 19, 2017 entitled KITS, SYSTEMS, AND METHODS FOR RECREATING A DIGITAL IMAGE AS PHYSICAL ART, both of which applications are hereby incorporated by reference.

### BACKGROUND

The kits, systems, and methods described herein relate to reproducing digital art or any digital image into physical art. More specifically, the kits, systems, and methods relate to reproducing a digital image into physical art using a plurality of interlocking pieces, preferably with canvas (or otherwise paintable) display faces, which can be considered a “mini canvas.”

### BRIEF SUMMARY

In accordance with one or more embodiments, a mini canvas kit is provided comprising a set of interlocking paintable pieces, each having a canvas or otherwise paintable display face. The interlocking pieces can be joined together side-by-side to form a larger full canvas that may be hung on a wall or otherwise displayed. Users are provided with instructions to paint each mini canvas with a particular color or colors and then assemble the mini canvases together to create artwork on the larger canvas. The artwork can comprise, e.g., a reproduction of a digital image. A computer program, e.g., a smartphone app, can be used to convert a desired digital image into instructions for users to paint a set of mini canvases (each covering a different specified section of the digital image) and assemble the mini canvases to create the full canvas representing the digital image. The instructions for painting each mini canvas can be provided to users in a variety of ways including, e.g., through smartphone (or other computer device) apps. In some embodiments, augmented reality techniques can be used to direct a user to paint a particular pattern on a mini canvas.

In accordance with one or more embodiments, an injection molding process is disclosed for forming a display face of an interlocking piece with a canvas covering. A canvas piece is placed flush against the inside surface of a mold half. After the mold is closed, a polymer (or other material used to form the display face) is injected into the mold cavity to form a display face with a canvas covering in a single operation. In one or more embodiments, one side of the canvas piece is covered by a paint primer such as Gesso. Preferably, the Gesso treated side of the canvas is underneath the exposed paintable surface. This orientation of the canvas piece has been found to provide surprisingly good paintability properties and adherence to the plastic piece.

In accordance with one or more embodiments, a kit is provided for reproducing a digital image into physical art. The digital image may be a photograph, a user-generated image, or some other suitable image. The kit includes a set of colors, art tools, a picture frame, and a plurality of interlocking pieces. The kit can be used with a computer program configured for determining an arrangement of picture elements that reproduces the digital image into physical art. Each of the picture elements forms a small and different portion of the overall image and is associated with one of the interlocking pieces. Users color the preferably canvas display face of each interlocking piece with at least one color to reproduce the associated picture element. Once the interlocking pieces have been colored, they are assembled by the user in a specified arrangement to form the image. The frame can be placed around the arranged interlocking pieces for decorative purposes and/or to keep the interlocking pieces in place.

In some embodiments, the kit may provide a user with access to the computer program such as, e.g., by including media storing computer code comprising the program in the kit, providing a Quick Response (QR) code to access the program, providing a web link to access the program, providing instructions for accessing the program, or through some other suitable access provision. Each interlocking piece in the plurality of interlocking pieces corresponds to a picture element in the arrangement of picture elements determined by the computer program and has at least one display face. Each color in the set of colors may be a pigment (e.g., paint, pencil, ink, charcoal), a sticker, or some other material suitable for providing one or more colors to the display face of an interlocking piece. The computer program instructs the user to apply one or more colors and/or shapes using any needed special art technique to the display face of each interlocking piece in the plurality of interlocking pieces based on the color or colors of the at least one corresponding picture element. The instructions may include multiple steps such as, e.g., using a pencil to outline shapes and then using paints to color the shapes. The program guides the user to assemble the interlocking pieces in the frame such that each interlocking piece has a relative position corresponding to that of the interlocking piece's corresponding picture element. In this way, the assembled interlocking pieces recreate the digital image as physical art. The frame holds the interlocking pieces in their relative positions, preferably without glue, and may be mounted on a wall or otherwise displayed.

In some embodiments, the colors comprise stickers. In some such embodiments, the kit further includes a blank page or pages of stickers, and the computer application is further configured to instruct a color printer to print a color matching at least one corresponding picture element color on to a sticker of the blank page of stickers. In some such embodiments, the computer application is further configured to print an ordinal number on the blank page of stickers adjacent to the printed sticker, wherein the ordinal number is associated with the relative position of an interlocking piece.

In some embodiments, each interlocking piece comprises a base with a display face thereon. Each interlocking piece includes two ribs projecting from two adjacent sides of the interlocking piece. The other two sides of the interlocking piece opposite from the projecting ribs each form slots for receiving projecting ribs from adjacent interlocking pieces when the interlocking pieces are assembled together. Each of the ribs and slots includes a releasable locking mechanism comprising a locking tab and a corresponding aperture. The locking mechanisms are complementary in that the locking tab and aperture of one rib engage an aperture and locking tab, respectively, of a slot of an adjacent interlocking piece. The locking tabs are resilient, enabling adjacent interlocking pieces to be slid into a locked position, and forcibly pulled apart when desired by the user.

In some alternate embodiments, each interlocking piece in the plurality of interlocking pieces comprises three connected tiles, wherein a first tile and a third tile are vertically offset from each other with a second, interlocking tile therebetween. The interlocking tile is offset from the first and third tiles such that it creates an opposing groove and rib, wherein the rib of one interlocking piece interlocks with the groove of an adjacent interlocking piece. The first and the third tile in each interlocking piece may each comprise a display face.

The display faces of each interlocking piece may comprise a variety of shapes such as, e.g., a parallelogram, a square, a circle, a triangle, a hexagon, an octagon, or some other suitable geometric figure. In some embodiments, each display face in an arrangement of interlocking pieces has the same geometric shape. In other embodiments, the shapes of the display faces in an arrangement of interlocking pieces can be varied.

In some embodiments, the display faces in an arrangement of interlocking pieces each have the same thickness. In other embodiments, the display faces in an arrangement of interlocking pieces may have varied thicknesses to provide depth to the artwork.

In some embodiments, the display faces in the interlocking pieces comprise flat surfaces. In other embodiments, the display faces form a three-dimensional shape such as, e.g., a pyramidal shape, a triangular prism shape, or a spherical shape.

In some embodiments, the frame comprises a horizontal segment configured to interlock with at least one of the plurality of interlocking pieces.

In accordance with one or more embodiments, a system is provided for reproducing a digital image. The digital image may be a photograph, a user-generated image, or some other suitable digital image. The system comprises a computer device including a computer processor and a plurality of interlocking pieces. The computer processor is configured for determining an arrangement of picture elements that will reproduce the digital image, wherein each picture element has a color and a relative position. In some embodiments, a user may edit the arrangement of picture elements determined by the computer processor. Each interlocking piece in the plurality of interlocking pieces corresponds to a picture element in the plurality of picture elements and comprises a display face. The display face of an interlocking piece has the color of the picture element corresponding to the interlocking piece, and the plurality of interlocking pieces is assembled such that each interlocking piece has a relative position corresponding to that of the interlocking piece's corresponding picture element. In some embodiments, an interlocking piece may be reversible; the interlocking piece may have a second display face arranged opposite a first display face such that the second display face may be used instead of the first display face by flipping the interlocking piece over.

### BRIEF DESCRIPTION OF THE DRAWINGS

For the purpose of explanation, several embodiments are set forth in the following drawings.

FIG. 1 illustrates an exemplary system for recreating a digital image as physical art in accordance with one or more embodiments;

FIG. 2 illustrates another exemplary system for recreating a digital image as physical art in accordance with one or more embodiments;

FIG. 3A is a perspective view of an exemplary interlocking piece according to one or more embodiments;

FIG. 3B is a front view of an exemplary interlocking piece in accordance with one or more embodiments;

FIG. 4 is a perspective view of an exemplary frame in accordance with one or more embodiments;

FIG. 5 is a perspective view of another exemplary frame in accordance with one or more embodiments;

FIG. 6 is a flow chart illustrating an exemplary image reproduction process in accordance with one or more embodiments; and

FIG. 7 is a block diagram of an exemplary computing device for performing any of the processes described herein in accordance with one or more embodiments.

FIGS. 8A-8F show various views of an exemplary interlocking piece in accordance with one or more further embodiments.

FIGS. 9A-9D show various views of corner portions of exemplary frames in accordance with one or more embodiments suitable for holding the interlocking pieces of FIGS. 8A-8F.

FIG. 10 shows an exemplary piece of canvas that can cover the display face of an interlocking piece in accordance with one or more embodiments.

FIG. 11 shows an exemplary interlocking piece having a canvas display face in accordance with one or more embodiments.

FIGS. 12A-12D illustrate an exemplary process for forming a display face with a canvas covering in accordance with one or more embodiments.

FIG. 13 shows a perspective view of one half of an exemplary mold used in the process illustrated in FIGS. 12A-12D in accordance with one or more embodiments.

FIG. 14 shows a display face with canvas covering formed by the process illustrated in FIGS. 12A-12D in accordance with one or more embodiments.

FIG. 15 shows the display face with canvas covering of FIG. 14 having decorative overmolded ribs in accordance with one or more embodiments.

### DETAILED DESCRIPTION

In the following description, numerous details are set forth for the purpose of explanation. However, one of ordinary skill in the art will realize that the embodiments described herein may be practiced without the use of these specific details and that the embodiments described herein may be modified, supplemented, or otherwise altered without departing from the scope of the systems and methods described herein.

The kit, systems, and methods described herein relate to reproducing a digital image into physical art. Users may supply or generate the digital image, and a user computer device determines an arrangement of picture elements that represents the digital image. Each picture element has at least one color, a position relative to other picture elements, and a corresponding interlocking piece with a display face. A color or colors corresponding to the picture element color or colors is applied to the display face of the picture element's corresponding interlocking piece, and the interlocking pieces are arranged such that each interlocking piece has a relative position corresponding to the relative position of its corresponding picture element in the image.

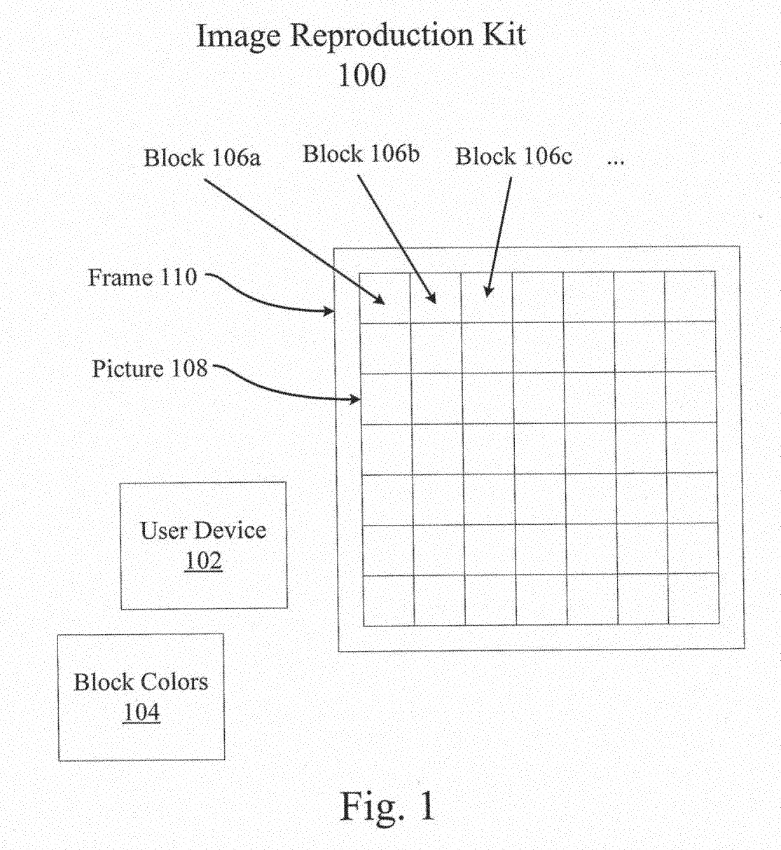

FIG. 1 is an illustrative block diagram of an exemplary image reproduction system 100 in accordance with one or more embodiments. A user generates or selects a digital image to be reproduced on the user device 102, which may include drawing a picture, taking a photograph, downloading a picture, selecting a picture stored on the user device, or identifying the picture in some other suitable fashion. In embodiments in which a user takes a photograph with user device 102, user device 102 may display a preview of how a photo will appear given the user's selection of camera options, such as exposure time, f-stop, application of color filters, or other suitable image-capture options. In some embodiments, the user may selectively modify the image shown in the picture preview using various techniques such as filters before recording the modified image in the user device. In some embodiments, the user can selectively change the resolution of different parts of the image shown on the user device. This can be done, e.g., by the user moving his or her finger across the surface of a touch-screen device, in one direction to increase the resolution and the opposite direction to decrease the resolution, i.e., pixelate the image. The user device then instructs the user on coloring and assembling the interlocking pieces to recreate the digital image as artwork.

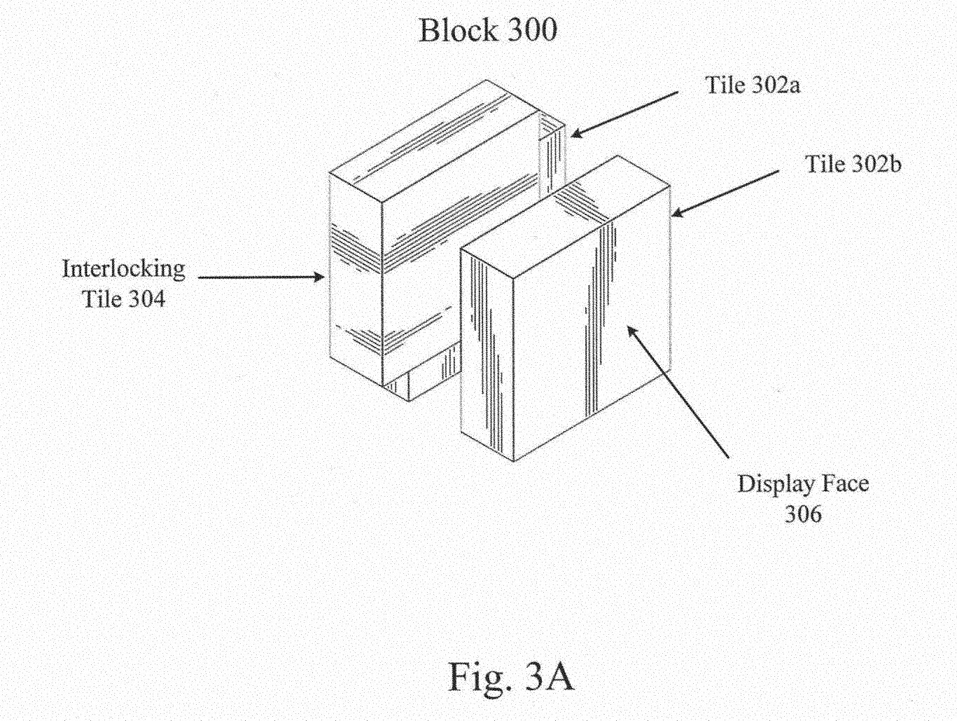

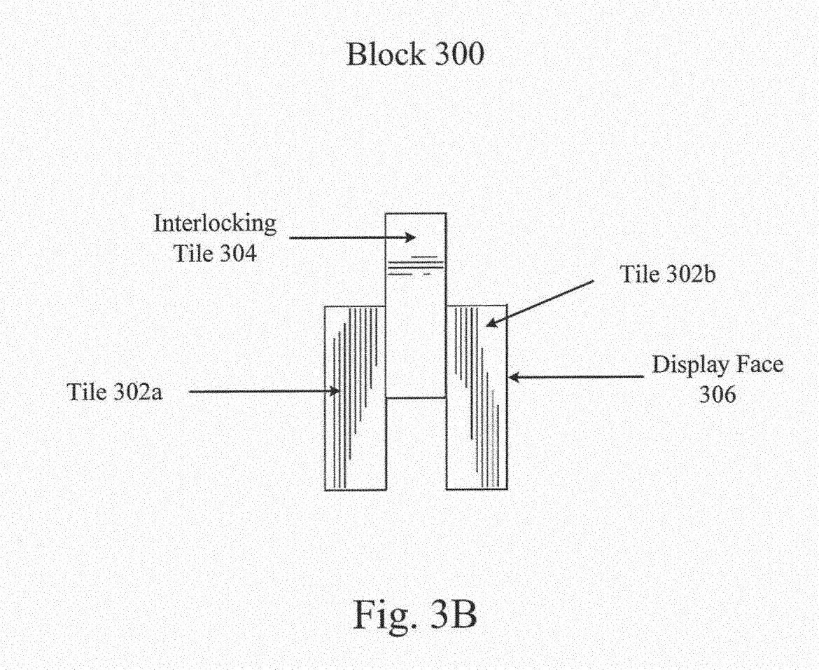

The user may then apply one or more colors 104 to the display face of each of interlocking pieces 106a-c and other, similar interlocking pieces (collectively, interlocking pieces 106). An interlocking piece 106 is described in more detail in relation to FIG. 3. There may be a different number of interlocking pieces 106 than are depicted. By arranging interlocking pieces 106 based on the arrangement of picture elements identified by user device 102, the user forms physical picture 108, a reproduction of the user-identified digital image. In one or more embodiments, the device 102 provides an estimate of how long it will take a user to form picture 108 from interlocking pieces 106 and/or the level of difficulty in recreating the subject image in real time as the user modifies or selects the digital image to be reproduced. The interlocking pieces may be assembled in frame 110 in their respective relative positions to secure them in place. In one or more embodiments, the frame holds the interlocking pieces in place without use of glue. Frame 110 is described in more detail in relation to FIG. 4. Frame 110 may have a different shape than depicted.

Colors 104 may be paints, colored stickers, or other suitable materials for changing the color of a display face of an interlocking piece. In some implementations, user device 102 selects picture element colors from a set of colors corresponding to the colors available in the set of colors 104. As an illustrative example of such implementations, if colors 104 comprise red, orange, yellow, green, blue, purple, black, and white paints, each picture element identified by user device 102 will be the same or similar shade of red, orange, yellow, green, blue, purple, black, or white.

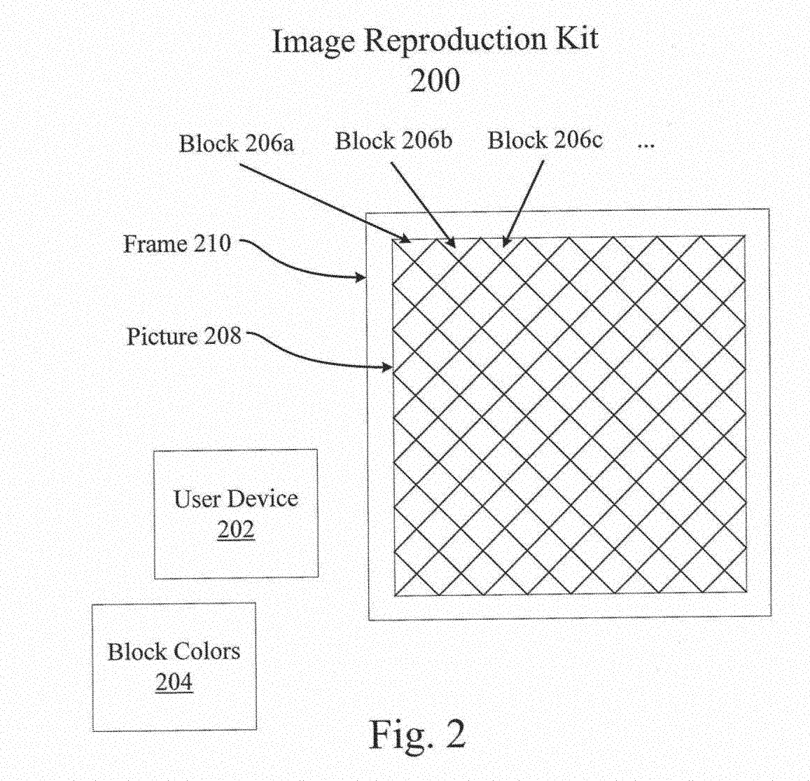

FIG. 2 is an illustrative block diagram of another exemplary image reproduction system 200 in accordance with one or more embodiments. A user generates or selects a digital image to be reproduced on the user device 202, which may include drawing a picture, taking a photograph, downloading a picture, selecting a picture stored on the user device, or identifying the picture in some other suitable fashion. In embodiments in which a user takes a photograph with user device 202, user device 202 may display a preview of how a photo will appear given the user's selection of camera options, such as exposure time, f-stop, application of color filters, or other suitable image-capture options. In some embodiments, the user may selectively modify the image shown in the picture preview using various techniques such as filters before recording the modified image in the user device. In some embodiments, the user can selectively change the resolution of different parts of the image shown on the user device. This can be done, e.g., by the user moving his or her finger across the surface of a touch-screen device, in one direction to increase the resolution and the opposite direction to decrease the resolution, i.e., pixelate the image. The user device then instructs the user on coloring and assembling the interlocking pieces to recreate the digital image as artwork.

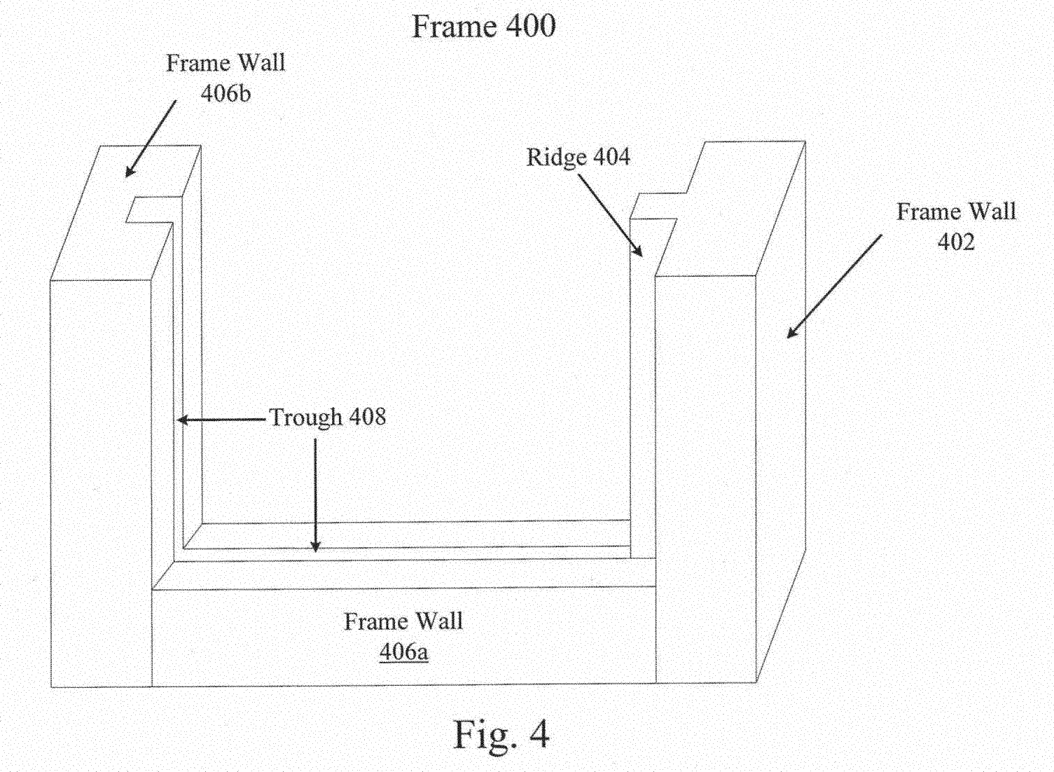

The user may then apply one or more colors 204 to the display face of each of interlocking pieces 206a-c and other, similar interlocking pieces (collectively, interlocking pieces 206). An interlocking piece 206 is described in more detail in relation to FIG. 3. There may be a different number of interlocking pieces 206 than are depicted. By arranging interlocking pieces 206 based on the arrangement of picture elements identified by user device 202, the user forms physical picture 208, a reproduction of the user-identified digital image. In one or more embodiments, the device 202 provides an estimate of how long it will take a user to form picture 208 from interlocking pieces 206 and/or the level of difficulty in recreating the subject image in real time as the user modifies or selects the digital image to be reproduced. The interlocking pieces may be assembled in frame 210 in their respective relative positions to secure them in place. In one or more embodiments, the frame holds the interlocking pieces in place without use of glue. Frame 210 is described in more detail in relation to FIG. 5. Frame 210 may have a different shape than depicted.

Colors 204 may be paints, colored stickers, or other suitable materials for changing the color of a display face of an interlocking piece. In some implementations, user device 202 selects picture element colors from a set of colors corresponding to the colors available in colors 204. As an illustrative example of such implementations, if colors 204 comprise red, orange, yellow, green, blue, purple, black, and white paints, each picture element identified by user device 202 will be the same or similar shade of red, orange, yellow, green, blue, purple, black, or white.

FIG. 3A is a perspective view of an illustrative embodiment of an interlocking piece 300. FIG. 3B is a front view of the same illustrative embodiment of interlocking piece 300. Interlocking piece 300 may be composed of one or more of wood, a tile, a plastic, a metal, or some other suitable material, and may be one of the interlocking pieces 106 of FIG. 1. Interlocking piece 300 includes tiles 302a and 302b (collectively, tiles 302) sandwiching an interlocking tile 304. Interlocking tile 304 is offset from tiles 302 such that it creates two pairs of opposing grooves and ribs, respectively at the top and bottom and at the sides of interlocking piece 300. The rib at the top of one interlocking piece may interlock with the groove at the bottom of a second interlocking piece, and the rib at the side of one interlocking piece may interlock with the groove at the opposing side of a third interlocking piece. Display face 306 is the face of interlocking piece 300 that will be visible to a viewer of picture 108; as depicted, display face 306 comprises the large outer face of tile 302b, but in some embodiments may comprise the large outer face of tile 302a. In some embodiments, the large outer faces of tiles 302a and 302b may each comprise a display face 306, such that the interlocking piece may present the same or a different appearance based on which of the tiles 302 face the user. A user may hold interlocking piece 300 by interlocking tile 304 while painting display face 306.

While tiles 302 and interlocking tile 304 are depicted as parallelepipeds with two square faces, one or more of tiles 302 and/or interlocking tile 304 may have different shapes than depicted. As an illustrative example, a tile 302 may take the shape of a cylinder, giving display face 306 the shape of a circle. Similarly, a tile 302 may have a display face shaped like a triangle, a hexagon, an octagon, or some other suitable polygon. In such embodiments, interlocking tile 304 may have the same shape as tile 302b or may have a different shape. As an illustrative example, interlocking tile 304 may be shaped as a square parallelepiped when tiles 302 are shaped like cylinders. Similarly, as two identical isosceles right triangles will form a square when adjacent to each other along their hypotenuse, tiles 302 and interlocking tile 304 may be isosceles right triangles.

Interlocking piece 300 interlocks with similar interlocking pieces such that their respective colors on their respective display faces form picture 108. Interlocking piece 300 may interlock with similar interlocking pieces such that the boundaries of display face 306 contact the boundaries of the respective display faces of all interlocking pieces adjacent to interlocking piece 300. In some embodiments, display face 306 is formed such that there is a gap between one of its boundaries and a boundary of a neighboring display face. In some such embodiments, user device 102 may further identify a color 104 for the user to apply to the side of interlocking tile 304 that contacts tile 302b.

FIG. 4 is an illustrative embodiment of a frame 400, which may correspond to frame 110 of FIG. 1. Frame 400 includes frame wall 402, which has a ridge 404. Referring to FIG. 3, ridge 404 may interlock with an interlocking piece 300 such that tiles 302a and 302b lie on either side of ridge 408. Similarly, frame 400 includes frame walls 406a and 406b (collectively, frame walls 406), which include a trough 408 that may interlock with an interlocking piece 300 such that interlocking tile 304 lies within trough 408. Frame wall 406a may be removably or permanently attached to frame walls 402 and 406b using an adhesive, a nail, a screw, a latch, or some other suitable fastener. As depicted, a number of interlocking pieces 300 may be placed between frame walls 402 and 406b such that the interlocking pieces interlock with both each other and frame 400. In some implementations, frame 400 may include a further frame wall having a ridge similar to ridge 404. In such implementations, the further frame wall may be removably or permanently attached to one or more of frame walls 402 and 406b once interlocking pieces 106 have been placed inside the frame in order to hold picture 108 in place without the use of an adhesive. In some implementations, frame wall 406a may have a ridge 404 instead of trough 408. In such implementations, any further frame wall attached to frame walls 402 and 406b would have a trough 408 rather than a ridge 404.

In some implementations, ridge 404 and trough 408 may not be straight as depicted in FIG. 4. As an illustrative example, the interlocking pieces are oriented to form diamond shapes as shown in FIG. 2, and the ridge 404 and trough 408 may have a sawtooth shape, as depicted in relation to FIG. 5 to accommodate the diamond orientation of the interlocking pieces.

In some implementations, frame 400 may only include two frame walls connected at right angles to each other. In such implementations, frame 400 may include both a ridge 404 and a trough 408, only a ridge 404, or only a trough 408.

In some implementations, one or more of frame walls 402 and 406 may vary in one or more of height, width, and depth from their depiction here. As an illustrative example, the portion of the frame surrounding display faces 306 may be smaller than is depicted. In some implementations, frame wall 402 and any additional frame walls having a ridge 404 may include only a ridge 404: such a frame wall 402 will interlock with interlocking pieces 300, but will not extend beyond any display faces 306.

In some implementations, frame 400 may take a different shape than is here depicted, and may include a different number of frame walls than is here depicted. As an illustrative example, if every interlocking piece 300 has a display face 306 shaped like a hexagon instead of a square, frame 400 may also be hexagonally shaped. Similarly, in some implementations one or more of frame walls 402 and 406 may have a different shape than here depicted: such frame walls may be designed to hold non-square interlocking pieces 106 to duplicate a rectangular picture 108, and in some such implementations may hide those conceal those portions of interlocking pieces 106 extending beyond the boundaries of the picture 108.

In some implementations, one or more of frame walls 402 and 406 may be constructed from a plurality of component interlocking pieces with an appropriate cross-sectional profile.

FIG. 5 is another illustrative embodiment of a frame 500, which may correspond to frame 210 of FIG. 2. Referring to FIG. 4, frame 500 is similar to frame 400, including frame wall 502 with a ridge 504 that may interlock with an interlocking piece 300 such that tiles 302a and 302b lie on either side of ridge 504. Similarly, frame 500 includes frame walls 506a and 506b (collectively, frame walls 506), which include a trough 508 that may interlock with an interlocking piece 300 such that tiles 302 lie partially within trough 508. Frame wall 506a may be removably or permanently attached to frame walls 502 and 506b using an adhesive, a nail, a screw, a latch, or some other suitable fastener. As depicted, a number of interlocking pieces 300 may be placed between frame walls 502 and 506b such that the interlocking pieces interlock with both each other and frame 500. In some implementations, frame 500 may include a further frame wall having a ridge similar to ridge 504. In such implementations, the further frame wall may be removably or permanently attached to one or more of frame walls 502 and 506b once interlocking pieces 206 have been placed inside the frame in order to hold picture 308 in place without the use of an adhesive. In some implementations, frame wall 506a may have a ridge 504 instead of trough 508. In such implementations, any further frame wall attached to frame walls 502 and 506b would have a trough 508 rather than a ridge 504.

In some implementations, frame 500 may only include two frame walls connected at right angles to each other. In such implementations, frame 500 may include both a ridge 504 and a trough 508, only a ridge 504, or only a trough 508.

In some implementations, one or more of frame walls 502 and 506 may vary in one or more of height, width, and depth from their depiction here. As an illustrative example, the portion of the frame surrounding display faces 306 may be smaller than is depicted. In some implementations, frame wall 502 and any additional frame walls having a ridge 504 may include only a ridge 504: such a frame wall 502 will interlock with interlocking pieces 300, but will not extend beyond any display faces 306.

In some implementations, one or more of frame walls 502 and 506 may be constructed from a plurality of component interlocking pieces with an appropriate cross-sectional profile.

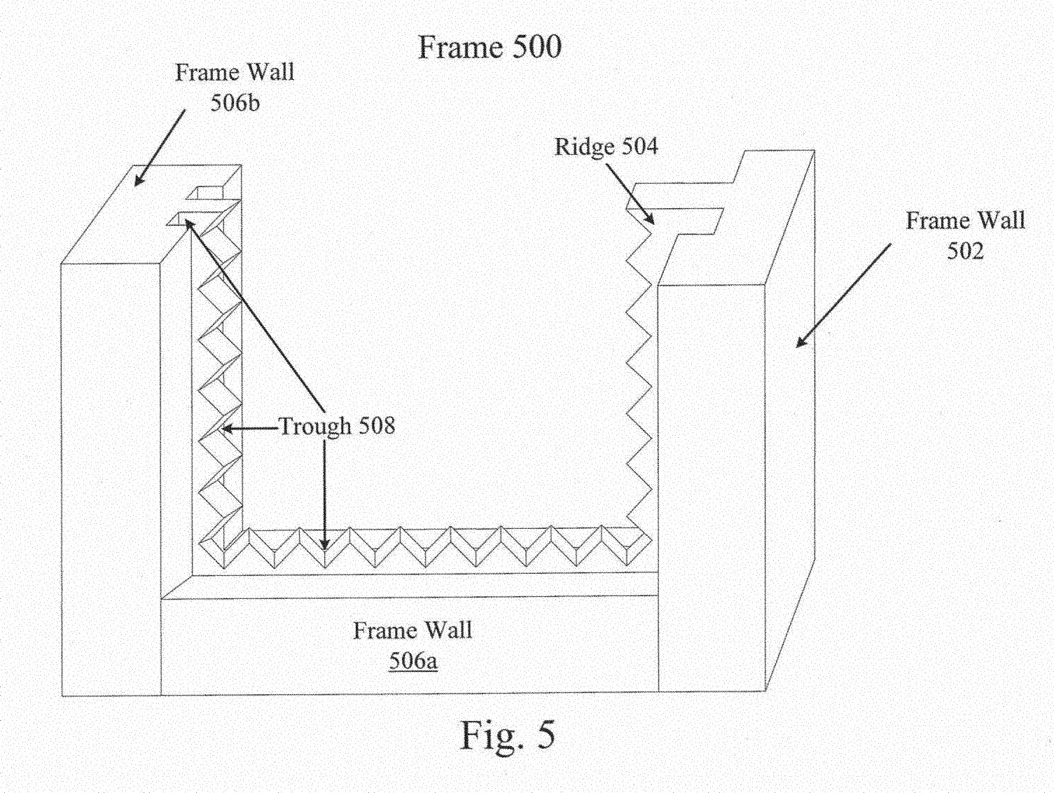

FIG. 6 is an illustrative flow chart of an image reproduction process 600. Image reproduction process 600 reproduces a digital image using a plurality of interlocking pieces. Process 600 begins with step 601, in which a user identifies the digital image to be reproduced. Referring to FIG. 1, the user may take a photo using user device 102, create an image on user device 102, identify an image stored locally on user device 102, identify an image on a remote server to user device 102, or identify the digital image in some other suitable fashion. In step 602, user device 102 identifies reproduction parameters, which may include the size of the interlocking pieces 106, the shape of the interlocking pieces 106, the minimum or maximum dimensions of picture 108, the colors available in colors 104, or other suitable parameters. Each reproduction parameter may be permanently established, set by a user, or selected from a pre-determined set of choices by a user. As an illustrative example, a user may be able to choose the color palette of colors 104, set the dimensions of the final picture 108 in terms of the number of interlocking pieces, and may choose the shape of the display faces of the interlocking pieces 106, but the dimensions of interlocking pieces 106 may be set according to the shape of the display faces of the interlocking pieces.

Once the digital image and the reproduction parameters have been identified, process 600 proceeds to step 603, in which user device 102 identifies picture elements that will meet the reproduction parameters and produce the digital image. User device 102 may identify picture elements by dividing the digital image into regions based on the reproduction parameter, and identifying picture element colors based on the regions. User device 102 may identify a picture element's color by, e.g., averaging the luminance and chrominance of its corresponding region, identifying the most common color in its corresponding region, randomly selecting a portion of its corresponding region as the picture element color, or through some other suitable method. User device 102 then displays a preview of the reproduction based on the identified picture elements in step 604. A user may edit the preview in step 605, which may include changing the reproduction parameters and repeating steps 603 and 604 accordingly, applying a uniform change to the picture element colors (e.g., applying a filter to the colors), editing individual picture elements to alter the reproduction, or providing some other suitable input.

Once the user has finalized the reproduction, user device 102 identifies the colors matching each picture element in step 606, and the user applies the identified colors to the display faces of corresponding interlocking pieces in step 607. User device 102 may carry out step 606 by displaying an instruction for coloring each picture element in order, by printing out relevant solid colors on to each sticker of a sheet of stickers in an array corresponding to the positions of the picture elements, or through some other suitable measure. The user completes step 607 accordingly: by painting display faces the indicated color, by applying stickers to display faces, or through following other instructions as appropriate.

The user arranges interlocking pieces 106 in frame 300 in step 608. As depicted, a user colors every interlocking piece 106 before arranging all of the interlocking pieces 106 in frame 300, but a user may alternatively add each interlocking piece 106 to frame 300 as the user colors the interlocking piece, or may arrange the interlocking pieces in some other suitable fashion. Once the user has added every interlocking piece 106 to frame 300, interlocking pieces 106 make up picture 108, and process 600 is complete. In some implementations, the user may also lock the interlocking pieces in place by closing the frame as described in reference to FIG. 3. In some embodiments, the user may also take a picture of the assembled picture 108 with user device 102, allowing the device to compare the assembled picture 108 to the original digital image and identify whether the user made any mistakes in assembly. In some such embodiments, user device 102 may further instruct the user in how to correct identified mistakes.

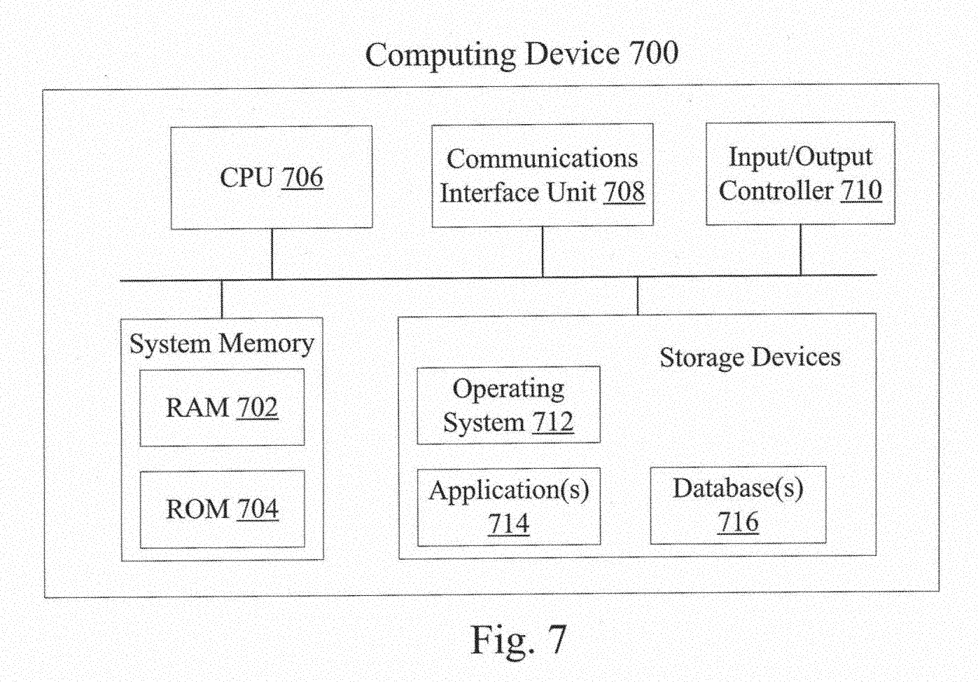

FIGS. 8A-8F show various views of an another exemplary interlocking piece 800 in accordance with one or more embodiments. The interlocking piece 800 includes a display face 802 integrally formed with or connected to a base structure 804. The display face 802 in this exemplary embodiment is square in shape. By way of example, each display face 802 has dimensions of 2″×2″, though generally any size can be used. It may also have a variety of other shapes like, e.g., the display faces of the interlocking pieces described previously.

The base structure 804 of the interlocking piece 800 includes two ribs 806 projecting from two adjacent sides of the interlocking piece 800. The other two sides of the interlocking piece 800 opposite from the projecting ribs 806 each form slots 808 configured for receiving projecting ribs 806 from adjacent interlocking pieces 800 when the interlocking pieces 800 are assembled together. In this way, the rib 806 at the top of a first interlocking piece 800 may interlock with the slot 808 at the bottom of an adjacent second interlocking piece 800, and the rib 806 at the side of first interlocking piece 800 may interlock with the slot 808 at an adjacent third interlocking piece 800.

Each of the ribs 806 and slots 808 includes a releasable locking mechanism comprising a locking tab 810 and an aperture 812. The locking mechanisms are complementary in that the locking tab 810 and aperture 812 of a rib 806 engages an aperture 812 and locking tab 810, respectively, of a slot 808 of an adjacent interlocking piece 800. The locking tabs 810 are resilient, enabling adjacent interlocking pieces 800 to be slid into a locked position, and forcibly pulled apart when desired by the user. No adhesive is needed to secure the interlocking pieces 800 together.

The interlocking pieces 800 may comprise a variety of suitable materials including, e.g., plastic, wood, and metal. In one embodiment, the interlocking pieces 800 comprise molded plastic. The molded plastic interlocking pieces 800 may each comprise a single integrated molded piece or multiple molded pieces that are assembled together. In one or more embodiments, a canvas covering (or other paintable material) may be applied over the display face 802 of each interlocking piece 800. In one or more embodiments, the display face 802 may have a Gesso coating.

When the display faces 802 includes a canvas covering, each interlocking piece can be considered to be a “mini canvas.” The interlocking pieces can be joined together side-by-side to form a larger “full” canvas that may be hung on a wall or otherwise displayed (e.g., as shown in FIG. 1). Users are provided with instructions to paint each mini canvas with a particular color or colors and then assemble the mini canvases together to create artwork on the full canvas. The artwork can comprise, e.g., a reproduction of a digital image. A computer program can be used to convert a desired digital image into instructions for users to paint each mini canvas and assemble the mini canvases to create the larger canvas. The instructions for painting each mini canvas can be provided to users in a variety of ways including, e.g., through smartphone (or other computer device) apps.

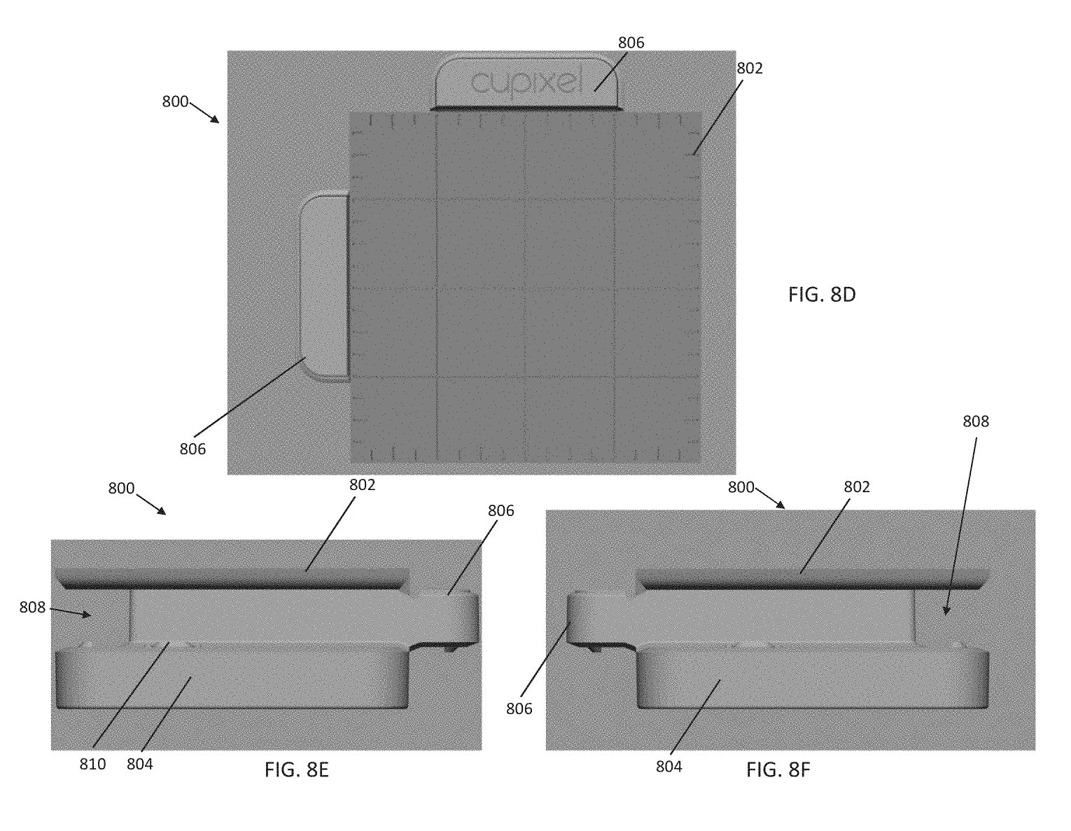

FIGS. 10-15 illustrate an exemplary process for manufacturing an interlocking piece with a canvas covered display face in accordance with one or more embodiments.

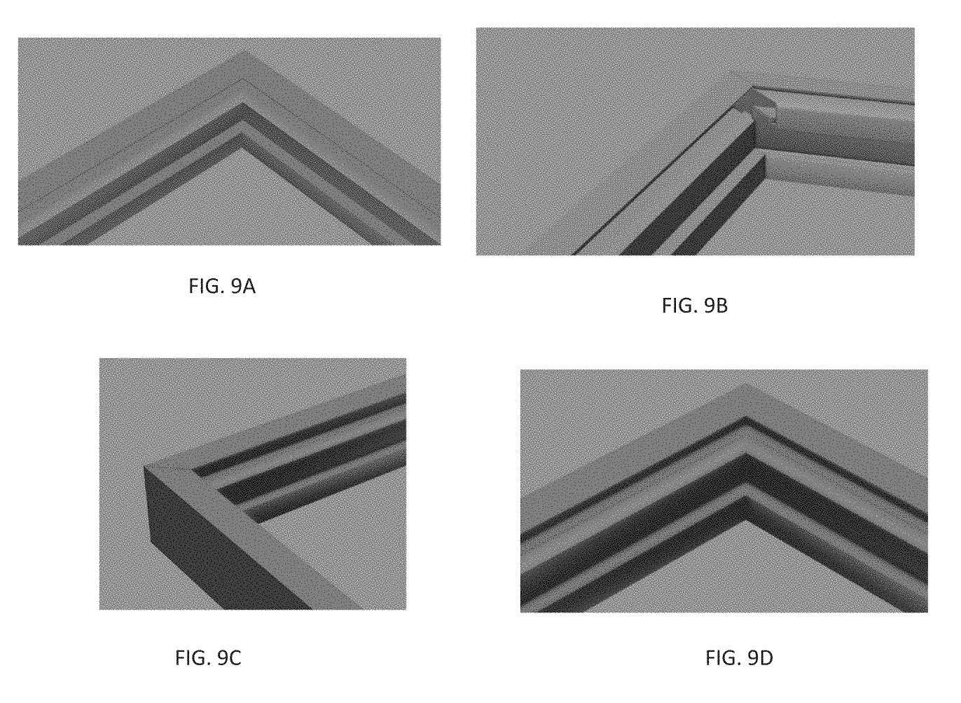

FIG. 10 shows an exemplary piece of canvas 1002 that can cover the display face of an interlocking piece 1004 as shown in FIG. 11. The canvas piece 1002 is preferably covered by a primer to improve the paintability of the display surface. In accordance with one or more embodiments, the primer is a Gesso primer applied to one side or both sides of the piece of canvas.

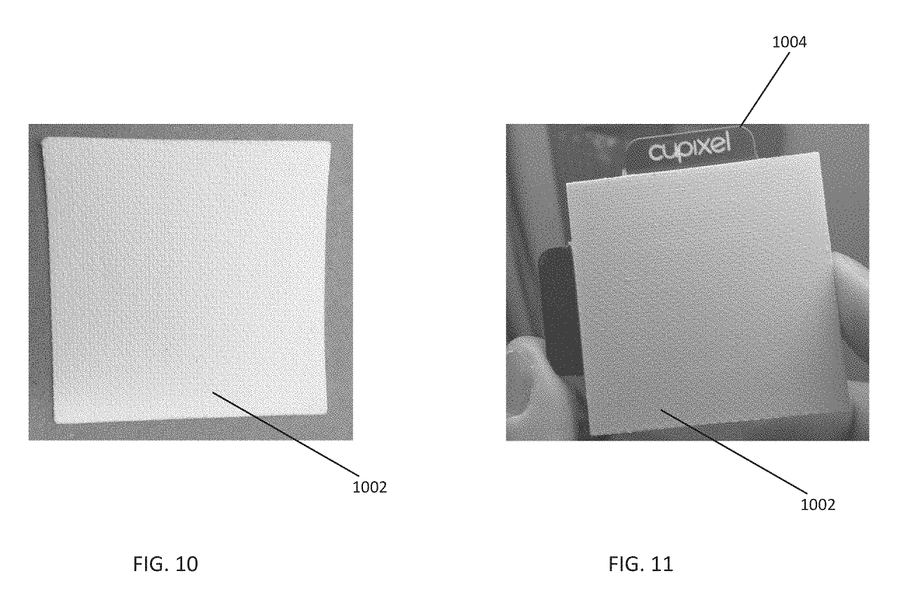

FIGS. 12A-12D show a molding machine used in an exemplary process for forming a display face of an interlocking piece with a canvas covering in a single process in accordance with one or more embodiments.

As shown in FIGS. 12A and 12B, canvas pieces 1002 are placed in flush against the inside surface of the front mold half 1006. The illustrated mold is designed for use with two canvas pieces 1002 to form the display faces of two separate interlocking pieces simultaneously in the mold.

The mold front half 1006 and back half 1008 are then brought together to close the mold as shown in FIG. 12C. A polymer (or other material used to form the display face) is then injected into the mold cavity. Once the cavity is filled, a holding pressure is maintained to compensate for material shrinkage. Once the formed display face is sufficiently cool, the mold is opened and the molded display face 1010 with a canvas covering is ejected as shown in FIG. 12D.

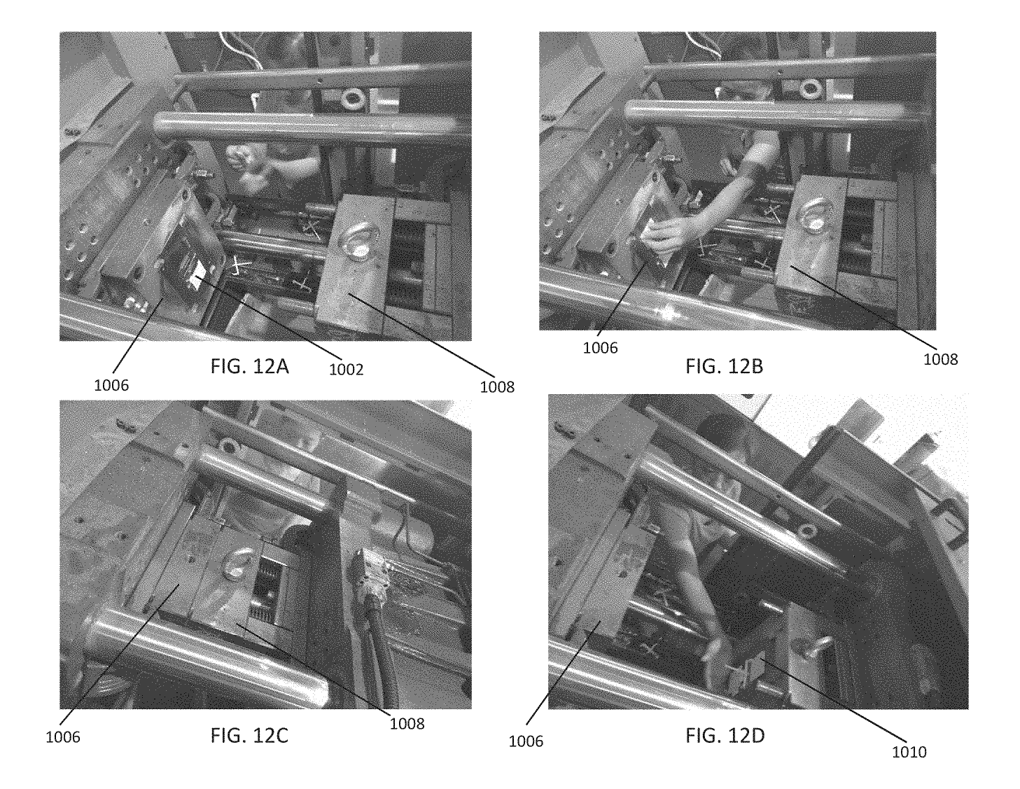

FIG. 13 shows a perspective view of the back half 1008 of the mold used in the process illustrated in FIGS. 12A-12D in accordance with one or more embodiments.

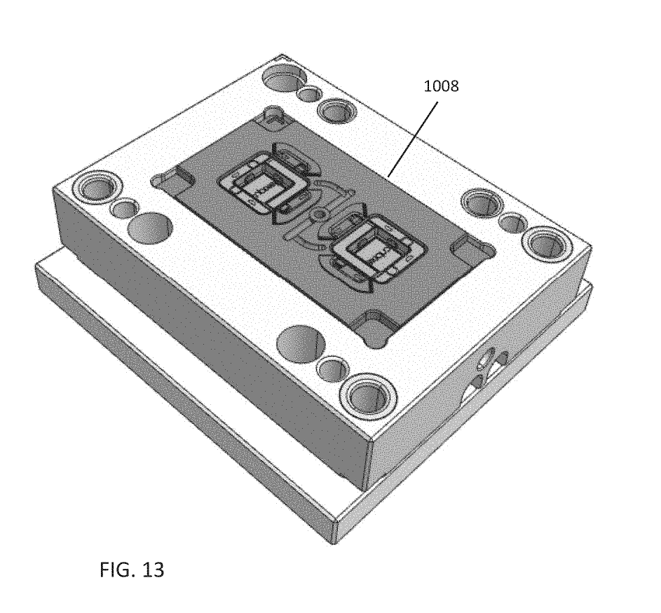

FIG. 14 shows the display face 1010 with canvas covering 1002 formed by the process illustrated in FIGS. 12A-12D in accordance with one or more embodiments.

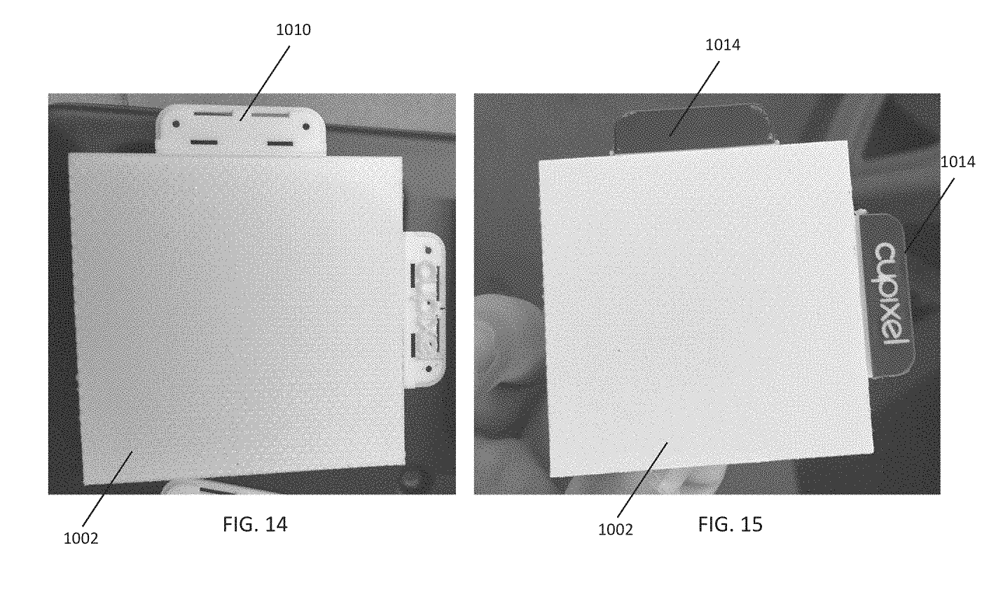

FIG. 15 shows the display face 1010 with canvas covering 1002 of FIG. 14 having a decorative layer 1014 overmolded on the ribs of the display face in a separate process in accordance with one or more embodiments. The display face can then be attached to a base structure (e.g., the base structure 804 shown in FIGS. 8A-8C) to form a completed interlocking piece.

In one or more alternate embodiments, the display face and the base structure form a single integrated molded piece. In such embodiments, the interlocking piece with the canvas display surface can be formed in a single molding operation.

As discussed above, preferably one side of the canvas piece 1002 is covered by a paint primer such as Gesso. Gesso improves the paintability of the canvas. Gesso also increases the stiffness of the canvas piece 1002, enabling it to be easily be positioned and retained in place in the mold cavity (shown, e.g., in FIGS. 12A and 12B).

In accordance with one or more embodiments, the canvas piece 1002 is placed in the mold such that the side of the canvas piece 1002 covered by Gesso faces the mold cavity. Thus, in the finished product, the side of the canvas previously treated with Gesso is underneath the exposed paintable surface. This orientation of the canvas piece 1002 has been found to provide surprisingly good paintability properties and adherence to the plastic piece.

In one or more alternate embodiments, the Gesso-treated side of the canvas is on the exposed paintable surface. In one or more further alternate embodiments, neither side of the canvas is pretreated by Gesso or any primer. In one or more further alternate embodiments, both sides of the canvas are pretreated by Gesso or any primer.

In some embodiments, augmented reality techniques can be used to direct a user to paint a particular pattern on a mini canvas. For example, a stand for a smartphone or tablet computer can be provided that is adapted to be positioned over the mini canvas. Users will be able to see, e.g., superimposed outlines of areas to be painted on a view of the mini canvas on the device screen.

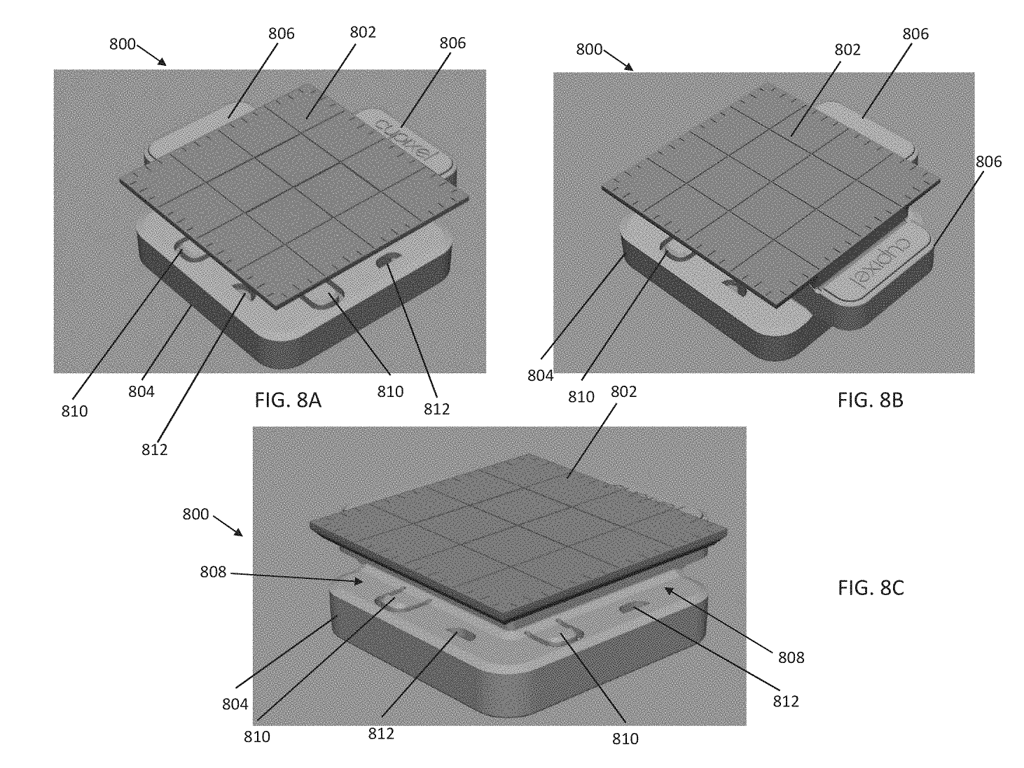

FIGS. 9A-9D show various views of corner portions of exemplary frames in accordance with one or more embodiments suitable for holding interlocking pieces 800 of FIGS. 8A-8F that have been painted (or otherwise colored) and assembled together forming a desired image. The frames may comprise a variety of suitable materials including, e.g., plastic, wood, and metal.

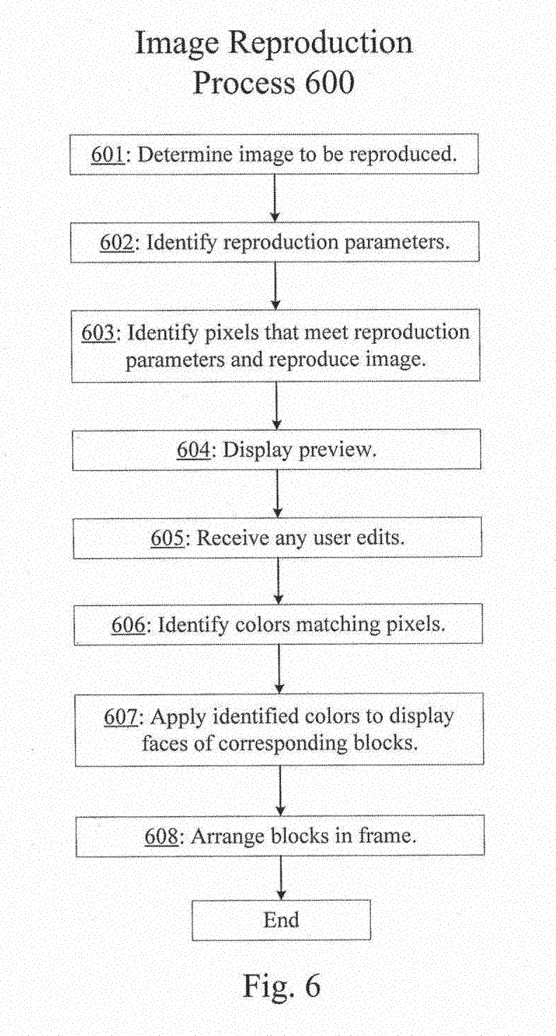

FIG. 7 is a block diagram of a computing device 700 that can be used to implement or support the user device of the kit of FIG. 1, and to perform any of the computer processes described herein. Computing device 700 may be a desktop computer, a laptop computer, a tablet computer, a smartphone, or some other suitable device. User device 102 may be implemented on one or more computing devices 700 having suitable circuitry. In certain embodiments, a component of user device 102 may be implemented across several computing devices 700. As an illustrative example of such embodiments, user device 102 may upload an image to a server through a computer network, and the server may then carry out step 603 of FIG. 6 and transmit the results to user device 102.

As depicted, the computing device 700 comprises a communications interface unit, an input/output controller 710, system memory, and one or more data storage devices. This can support a network connection such as a connection to the Internet. The system memory includes at least one random access memory (RAM 702) and at least one read-only memory (ROM 704). RAM 702 can store the image of step 601 of FIG. 6, for example. All of these elements are in communication with a central processing unit (CPU 706) to facilitate the operation of the computing device 700. The computing device 700 may be configured in many different ways. For example, the computing device 700 may be a conventional standalone computer or alternatively, the functions of computing device 700 may be distributed across multiple computer systems and architectures. In FIG. 7, the computing device 700 may be linked, via network or local network, to other servers or systems.

The computing device 700 may be configured in a distributed architecture, wherein databases and processors are housed in separate units or locations. Some units perform primary processing functions and contain, at a minimum, a general controller or a processor and a system memory. In distributed architecture embodiments, each of these units may be attached via the communications interface unit 708 to a communications hub or port (not shown) that serves as a primary communication link with other servers, client or user computers, and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM, and TCP/IP.

The CPU 706 comprises a processor, such as one or more conventional microprocessors and one or more supplementary co-processors such as math co-processors for offloading workload from the CPU 706. The CPU 706 is in communication with the communications interface unit 708 and the input/output controller 710, through which the CPU 706 communicates with other devices such as other servers, user terminals, or devices. The communications interface unit 708 and the input/output controller 710 may include multiple communication channels for simultaneous communication with, for example, other processors, servers, or client terminals.

The CPU 706 is also in communication with the data storage device. The data storage device may comprise an appropriate combination of magnetic, optical, or semiconductor memory, and may include, for example, RAM 702, ROM 704, flash drive, an optical disc such as a compact disc, or a hard disk or drive. The CPU 706 and the data storage device each may be, for example, located entirely within a single computer or other computing device; or connected to each other by a communication medium, such as a USB port, serial port cable, a coaxial cable, an Ethernet cable, a telephone line, a radio frequency transceiver, or other similar wireless or wired medium or combination of the foregoing. For example, the CPU 706 may be connected to the data storage device via the communications interface unit 708. The CPU 706 may be configured to perform one or more particular processing functions.

The data storage device may store, for example, (i) an operating system 712 for the computing device 700; (ii) one or more applications 714 (e.g., computer program code or a computer program product) adapted to direct the CPU 706 in accordance with the kits, systems, and methods described here, and particularly in accordance with identifying a plurality of picture elements to reproduce a digital image and other processes described in detail with regard to FIG. 6; or (iii) database(s) 716 adapted to store information that may be utilized to store information required by the program. The depicted database 716 can be any suitable database system, and can be a local or distributed database system.

The operating system 712 and applications 714 may be stored, for example, in a compressed, an uncompiled, and an encrypted format, and may include computer program code. The instructions of the program may be read into a main memory of the processor from a computer-readable medium other than the data storage device, such as from the ROM 704 or from the RAM 702, or from a computer data signal embodied in a carrier wave, such as that found within the well-known Web pages transferred among devices connected to the Internet. While execution of sequences of instructions in the program causes the CPU 706 to perform the process steps described herein, hard-wired circuitry may be used in place of, or in combination with, software instructions for embodiment of the processes of the present disclosure. Thus, the systems and methods described are not limited to any specific combination of hardware and software.

Suitable computer program code may be provided for performing one or more functions in relation to an image reproduction system as described herein. The program also may include program elements such as an operating system 712, a database management system, and “device drivers” that allow the processor to interface with computer peripheral devices (e.g., a video display, a keyboard, a computer mouse, a printer, etc.) via the input/output controller 710.

The term “computer-readable medium” as used herein refers to any non-transitory medium that provides or participates in providing instructions to the processor of the computing device 700 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 706 (or any other processor of a device described herein) for execution. For example, the instructions may initially be borne on a magnetic disk of a remote computer (not shown). The remote computer can load the instructions into its dynamic memory and send the instructions over an Ethernet connection, a cable line, or even a telephone line using a modem. A communications device local to a computing device 700 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic, or optical signals, which are exemplary forms of wireless communications or data streams that carry various types of information.

Some embodiments of the above described may be implemented by the preparation of application-specific integrated circuits or by interconnecting an appropriate network of conventional component circuits, as will be apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

While various embodiments of the present disclosure have been shown and described herein, it will be obvious to those skilled in the art that such embodiments are provided by way of example only. Numerous variations, changes, and substitutions will now occur to those skilled in the art without departing from the disclosure. As illustrative examples, a user may take a photo of block colors and provide such photos to user device 102 to more accurately model the ultimate reproduction of the digital image; a user may provide lighting conditions as a parameter for identifying picture element colors; interlocking pieces may have a color to begin with such that users may not need to color the interlocking pieces themselves; interlocking pieces may have display faces of varying size, which may allow the user to create picture 108 as a halftone image; a first tile 202b associated with a first interlocking piece 200 may have a different thickness than a second tile 202b associated with a second interlocking piece 200, such that a picture 108 may be composed of display faces at varying depths; or a tile 202b may have a non-uniform surface, which may allow picture 108 to incorporate various effects such as appearing different when viewed at differing angles. It should be understood that various alternatives to the embodiments of the disclosure described herein may be employed in practicing the disclosure. Elements of an embodiment of the systems and methods described herein may be independently implemented or combined with other embodiments.

What is claimed is:

1. A method of manufacturing a set of paintable pieces, each paintable piece including a display face, said paintable pieces configured to be assembled together such that the display faces can be arranged side-by-side to form an artwork canvas, the method for manufacturing each paintable piece comprising the steps of:
(a) positioning a canvas piece against an inside surface of one portion of a mold;
(b) securing a second portion of the mold to the first portion to form a mold cavity therebetween containing the canvas piece;
(c) feeding a molten polymer into the mold cavity such that the polymer fills the mold cavity and solidifies to form an paintable piece with the canvas piece forming a display face;
(d) separating the first and second portions of the mold and removing the paintable piece from the mold cavity; and
(e) repeating steps (a) through (d) a plurality of times to manufacture a set of paintable pieces.

2. The method of claim 1, wherein the one side of the canvas piece is covered by a paint primer.

3. The method of claim 2, wherein said one side of the canvas piece is positioned in the mold facing the mold cavity.

4. The method of claim 2, wherein the paint primer comprises Gesso.

5. The method of claim 1, wherein the display face has a square shape.

6. The method of claim 5, wherein each paintable piece includes two ribs projecting from two adjacent sides of the paintable piece and two corresponding slots on the other two sides of the paintable piece opposite from the projecting ribs, wherein the slots are configured for interlocking with projecting ribs from adjacent paintable pieces when the paintable pieces are assembled together.

7. The method of claim 6, wherein a rib at a top side of one paintable piece may interlock with a slot at a bottom side of an adjacent paintable piece, and a rib at a side of said one paintable piece may interlock with a slot at another adjacent paintable piece.

8. The method of claim 6, further comprising forming a decorative element overmolded on at least one rib of each paintable piece.

9. The method of claim 1, further comprising attaching a base structure to the paintable piece, said base structure including two ribs projecting from two adjacent sides of the paintable piece and two corresponding slots on the other two sides of the paintable piece opposite from the projecting ribs, wherein the slots are configured for interlocking with projecting ribs from adjacent paintable pieces when the paintable pieces are assembled together.

10. A set of paintable pieces, each including a display face, said paintable pieces configured to be assembled together such that the display faces can be arranged side-by-side to form an artwork canvas, wherein each paintable piece comprises a plastic structure and a canvas piece adhered to the plastic structure in a single operation molding process to form the display face.

11. The set of paintable pieces of claim 10, wherein in each paintable piece, one side of the canvas piece is covered by a paint primer.

12. The set of paintable pieces of claim 11, wherein in each paintable piece, the side of the canvas piece covered with a paint primer is fused to the plastic structure.

13. The set of paintable pieces of claim 11, wherein the paint primer comprises Gesso.

14. The set of paintable pieces of claim 1, wherein the display face in each paintable piece has a square shape.

15. The set of plastic paintable pieces of claim 14, wherein each paintable piece includes two ribs projecting from two adjacent sides of the paintable piece and two corresponding slots on the other two sides of the paintable piece opposite from the projecting ribs, wherein the slots are configured for interlocking with projecting ribs from adjacent paintable pieces when the paintable pieces are assembled together.

16. The set of paintable pieces of claim 15, wherein a rib at a top side of one paintable piece can interlock with a slot at a bottom side of an adjacent paintable piece, and a rib at a side of said one paintable piece can interlock with a slot at another adjacent paintable piece.

17. The set of paintable pieces of claim 15, wherein in each paintable piece, the plastic structure includes the ribs and the slots.

18. The set of paintable pieces of claim 15, wherein each paintable piece further includes a decorative element overmolded on at least one rib of the paintable piece.

19. A kit for reproducing a digital image into physical art, comprising:
a set of color paints;
a picture frame; and
a set of paintable pieces, each including a display face, said paintable pieces configured to be assembled together such that the display faces can be arranged side-by-side to form an artwork canvas, said artwork canvas configured to fit in said picture frame, wherein each paintable piece comprises a plastic structure and a canvas piece adhered to the plastic structure in a single operation molding process to form the display face, wherein a user can paint the canvas pieces using the set of color paints.

20. The kit of claim 19, wherein each paintable piece includes a releasable locking mechanism for connecting with an adjacent piece.
